(19) United States
(12) Patent Application Publication
(10) Pub. No.: US 2025/0239248 A1
(43) Pub. Date: Jul. 24, 2025

(54) AUDIO MASKING OF LANGUAGE

(71) Applicant: AUDIO MOBIL Elektronik GmbH, Braunau am Inn-Ranshofen (AT)

(72) Inventors: Thomas STOTTAN, Braunau am Inn (AT); Thomas HATHEIER, St. Peter am Hart (AT); Alois SONTACCHI, Gratwein-Straßengel (AT)

(73) Assignee: AUDIO MOBIL Elektronik GmbH, Braunau am Inn-Ranshofen (AT)

(21) Appl. No.: 18/702,209

(22) PCT Filed: Oct. 18, 2022
(86) PCT No.: PCT/EP2022/078926

§ 371 Date: Apr. 17, 2024

(30) Foreign Application Priority Data
Oct. 18, 2021 (EP) 21203247.8
Oct. 17, 2022 (EP) 22201974.7

(51) Int. Cl. G10K 11/175; G10L 25/18; G10L 25/84; H04S 3/00; H04S 7/00

(52) U.S. Cl. CPC G10K 11/1754; G10L 25/18; G10L 25/84; H04S 3/008; H04S 7/302; H04S 2400/01; H04S 2400/11

(57) ABSTRACT

The present disclosure relates to a method for masking a language signal in a zone-based audio system, involving: acquiring, in an audio zone, a language signal to be masked; transforming the acquired language signal into spectral bands; interchanging spectral values of at least two spectral bands; generating a noise signal on the basis of the interchanged spectral values; and outputting the noise signal as a masking signal for the language signal in another audio zone.

The present disclosure relates to the generation of a masking signal for speech in a zone-based audio system.

Prior art communication means and the constantly increasing coverage thereof enable almost everywhere communication, for example in the form of telephone calls. In public settings, other persons can often overhear such calls to understand the contents thereof. This is a particular problem when it comes to confidential private or business calls. Such a scenario may occur in public transportation, such as trains or planes, but also in private vehicles, such as cabs or rental limousines. In these cases, for example, there are other persons in assigned seats, in addition to the speaker. Such seats often have an associated audio system or at least components thereof. For example, loudspeakers for individual playback of audio contents can be provided in these seats, for example integrated into headrests, which is also referred to as a zone-based audio system.

In addition to telephone conversations, the problem of undesirable overhearing can also occur in conversations between people. For example, two passengers in the back of a cab may be talking about a confidential topic where it is undesirable for the driver to listen to.

In prior art, it is known that unwanted overhearing can be reduced by playing loud noise. However, this increases the noise level for all parties involved and is perceived as an unpleasant impairment, which can also affect attentiveness and the ability to react, which is particularly undesirable in road traffic.

The technical object of the present document is to generate a masking signal in a zone-based audio system that reduces unwanted overhearing of a conversation and at the same time does not represent an unpleasant impairment.

This object will be solved by the features of the independent claims. Advantageous embodiments are described in the dependent claims.

According to a first aspect, a method for masking a speech signal in a zone-based audio system is disclosed. The method comprises detecting a speech signal to be masked in an audio zone, for example by means of one or more suitably placed microphones, which may for example be arranged in a headrest of a seat. The speech signal can originate from the local speaker of a telephone conversation or belong to a conversation between persons being present. The detected speech signal is then transformed into spectral bands, which can be performed using FFT and Mel filters, for example. The method also involves commuting the spectral values of at least two spectral bands, which changes the spectral structure of the speech signal without changing its overall energy content. A noise signal (which is as broadband as possible) is then generated based on the commuted spectral values. Although the generated noise signal shows certain similarity to the spectrum of the speech signal, it does not match it completely, as the spectral structure of the speech signal is no longer fully preserved due to commuting the bands. Such a noise signal having similar but not the same spectrum as the speech signal is well suited as a masking signal for the speech signal. It should also be noted that any number of bands can be commuted (e.g. all of them), with more variation in the noise spectrum resulting from increased commutation of bands. Finally, the noise signal is output as a masking signal with the lowest possible energy input in another audio zone so as to make it more difficult for a person present at the listening—in location to overhear the conversation by reducing the speech intelligibility of this person.

Generating a noise signal based on the commuted spectral values can involve generating a broadband noise signal, e.g. using a noise generator, and transforming the noise signal generated into the frequency domain. Furthermore, multiplication of the frequency representation of the noise signal with a frequency representation of the speech signal can be performed while contemplating the commuted spectral values. Multiplication in the frequency domain generates a noise spectrum that essentially corresponds to that of the speech signal after the spectral bands have been commuted, i.e. it is similar but not the same as the speech spectrum. A similar effect can also be achieved by time domain convolution.

Frequency representation of the speech signal can be generated by interpolating the spectral values of the bands (e.g. as being present in the Mel range) after commuting the spectral values. Interpolation from the (relatively few) spectral values of the bands generates the values required at the frequency support values for multiplication by the noise spectrum.

The method may further comprise estimating a background noise spectrum (preferably at the listening—in location) and comparing spectral values of the speech signal with the background noise spectrum. Comparison of the spectral values preferably (but not necessarily) is done in the range of the spectral bands (e.g. Mel bands), which means that the background noise spectrum must also be displayed in the spectral bands. Furthermore, only spectral values of the speech signal that are greater than (or in a predetermined ratio to) the corresponding spectral values of the background noise spectrum can be contemplated for the further procedure (e.g. the above-mentioned interpolation). Spectral components of the speech signal that are already masked by the background noise do not need to be contemplated for generation of the masking signal and can be masked out (e.g. by setting them to zero). Considering the background noise can be performed both before and after commutation of spectral values. In the former case, the spectral bands to be compared still match exactly and the background noise is correctly taken. In the latter case, commutation of bands and masking of low energy bands in the speech signal introduces additional variation into the noise spectrum, which can result in increased masking. This enables a masking signal that is adapted to the background or environment and can be output with the lowest possible energy input in the audio zone of the overhearing person.

Transformation of the captured speech signal into spectral bands can be performed for blocks of the speech signal using a Mel filter bank. Optionally, it is possible to perform temporal smoothing of the spectral values for the Mel bands, e.g. in the form of a floating average.

In another embodiment of the invention, the noise signal can be spatially represented in the output using a multi-channel (i.e. at least 2-channel) reproduction. For this purpose, a multi-channel representation of the masking signal, which enables spatial reproduction of the masking signal, can be generated. For 2-channel systems, this can preferably be done by multiplication by binaural spectra of an acoustic transfer function. Spatial reproduction increases the effect of the masking signal to obfuscate the speech at the listening—in location, especially if the noise signal in the other audio zone is output in space such that it appears to originate from the direction of the speaker of the speech signal to be masked.

In addition to the masking signal described above, which is based on a broadband noise signal adapted to the speech signal, another component can be generated for the masking signal, which is output together to the overhearing person in the second audio zone. For this purpose, the method can include determining a time point in the speech signal that is relevant for speech intelligibility (e.g. the presence of consonants in the speech signal) and generating a suitable distraction signal for the specific time point. Then, the output of the distraction signal at the specific time can occur as another masking signal in the other audio zone, thus providing selective additional obscuring (masking) of the conversational content in speech onsets. As the distraction signal is only emitted at certain relevant time points, it does not significantly increase the overall sound level and does not lead to any significant impairment.

The time point relevant for speech intelligibility can be determined using extreme values (e.g. local maxima, onsets) of a spectral function of the speech signal, wherein the spectral function is determined based on an addition of spectral values across the frequency axis. The spectral values can be smoothed beforehand in the temporal and/or frequency direction. After adding the spectral values across the frequency axis, the sum values can optionally be logarithmized. In order to generate local maxima for the detection of relevant time points, the (optionally logarithmized) sum values can be time-differentiated.

Furthermore, the time points relevant for speech intelligibility can be verified using parameters of the speech signal, such as zero crossing rate, short-time energy and/or spectral centroid. It is also possible to take restrictions for extreme values, such that they require a predefined minimum time span.

The distraction signal for a specific time can then randomly be selected from a set of predetermined distraction signals. These can be maintained in a memory ready for selection. It has proven to be advantageous if the distraction signal is adapted to the speech signal in terms of spectral characteristics and/or energy thereof. In this way, the spectral centroid of the distraction signal can be adapted to the spectral centroid of the corresponding speech segment at the specific time, e.g. by means of single-sideband modulation. A speech segment having high spectral centroid can thus be masked using a distraction signal having an equally high spectral centroid (possibly even the same spectral centroid), which leads to higher masking effectiveness. The energy of the distraction signal can also be adapted to the energy of the speech segment so as not to generate a masking signal that is too loud and excessively disturbing.

In another embodiment of the invention, the distraction signal can be represented at the output using multi-channel spatial reproduction, preferably multiplication by binaural spectra of an acoustic transfer function, thereby generating a multi-channel {at least 2-channel) representation of the distraction signal which enables spatial reproduction of the distraction signal. Spatial reproduction increases the effect of the distraction signal for speech obfuscation at the co-listening location, especially if the distraction signal in the other audio zone is output spatially in such a way that it appears to originate from a random direction and/or close to the head of the listener in the other audio zone. This spatialization reduces distinguishability of the speech and distraction signal or makes it more difficult to overhear the speech signal due to the distraction signal and the energy for the distraction signal can thus be reduced.

The above-described speech signal processing and masking signal generation is preferably performed in the digital domain. For this purpose, steps not described in detail herein, such as analog-to-digital conversion and digital-to-analog conversion, are required, but will be obvious to persons skilled in the art having studied the present disclosure. Furthermore, the above-described method can be realized in total or in part using a programmable device comprising, in particular, a digital signal processor and analog/digital converters as required.

According to another aspect of the invention, a device for generating a masking signal in a zone-based audio system, which receives a speech signal to be masked and generates the masking signal based on the speech signal, is proposed. The device comprises means for transforming the detected speech signal into spectral bands; means for commuting spectral values from at least two spectral bands; and means for generating a noise signal as a masking signal based on the commuted spectral values.

The above embodiments of the method described therein can also be applied to this device. Thus, the device may further comprise: means for determining a time point in the speech signal relevant for speech intelligibility; means for generating a distraction signal for the relevant time point; and means for adding the noise signal and the distraction signal and for outputting the sum signal as a masking signal.

In another embodiment of the device, the device also comprises means for generating a multi-channel representation of the masking signal, enabling spatial reproduction of the masking signal.

According to a yet another aspect of the invention, a zone-based audio system having a plurality of audio zones is disclosed, wherein at least one audio zone comprises a microphone for detecting a voice signal and another audio zone comprises at least one loudspeaker. The microphone and the loudspeaker can be arranged in headrests of seats for passengers of a vehicle. It is also possible for both audio zones to have a microphone and a loudspeaker. The audio system has a device for generating a masking signal as shown above, which receives a speech signal from a microphone of the one audio zone and sends the masking signal to the loudspeaker or loudspeakers of the other audio zone.

Yet another aspect of the present disclosure relates to the generation of a distraction signal as a masking signal independently of the aforementioned noise signal as shown above. An appropriate method for masking a speech signal in a zone-based audio system comprises: detecting a speech signal to be masked in one audio zone; determining a time point in the speech signal relevant for speech intelligibility; generating a distraction signal for the time point determined, wherein the distraction signal may be adapted to the speech signal with respect to a spectral characteristic and/or energy thereof; and outputting the distraction signal at the time point determined as a masking signal in the other audio zone. The possible embodiments of the method correspond to the embodiments shown above in combination with the noise signal generated.

There is also disclosed an appropriate device for generating a distraction signal as a masking signal in a zone-based audio system, which receives a speech signal to be masked and generates the masking signal based on the speech signal. This device comprises means for determining a time point in the speech signal relevant for speech intelligibility; means for generating a distraction signal for the relevant time point, wherein the distraction signal can be adapted to the speech signal in terms of a spectral characteristic and/or energy thereof; and means for outputting the distraction signal as a masking signal. Optionally, means can be provided for generating a multi-channel representation of the masking signal, enabling spatial reproduction of the masking signal.

The features described above can be combined with each other in many ways, even if such a combination is not specifically mentioned. In particular, features described for a method can also be used for a related device and vice versa.

In the following, embodiments of the invention are described in more detail while making reference to the schematic drawing, wherein:

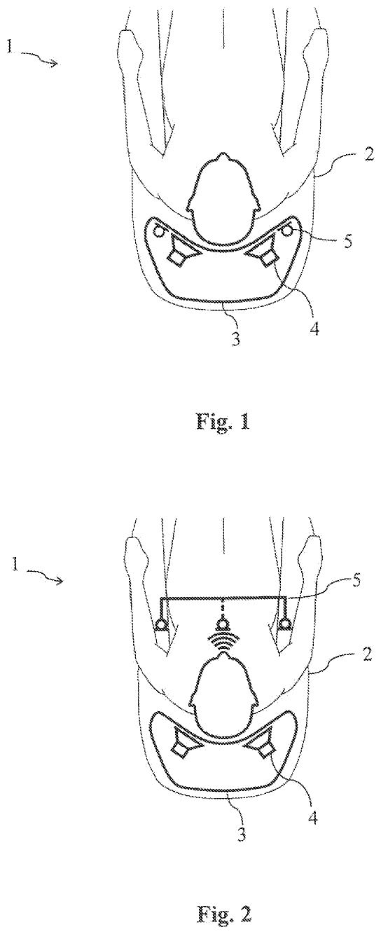

FIG. 1 schematically shows an example of a zone-based audio system;

FIG. 2 schematically shows another example for a zone-based audio system;

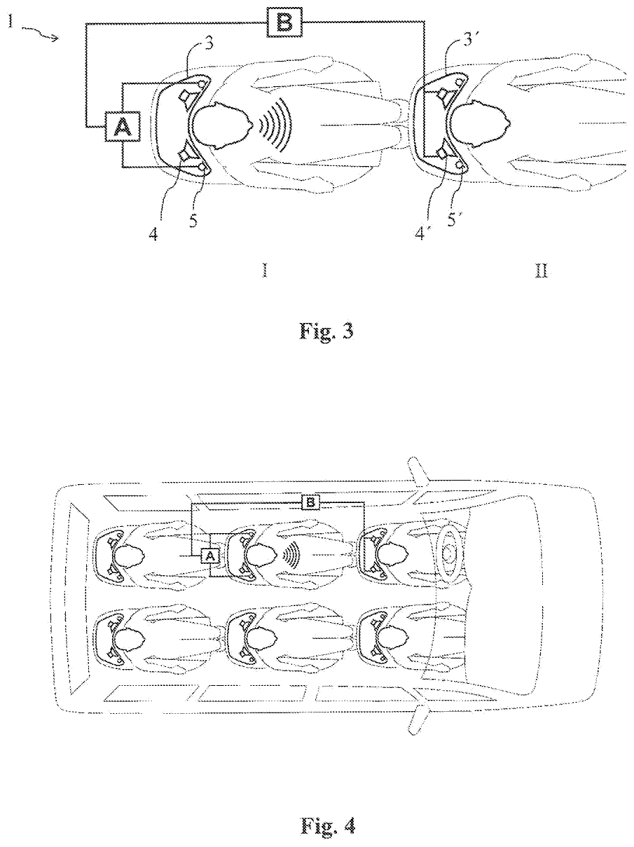

FIG. 3 schematically shows another example for a zone-based audio system having two zones;

FIG. 4 schematically shows another example for a zone-based audio system having several zones;

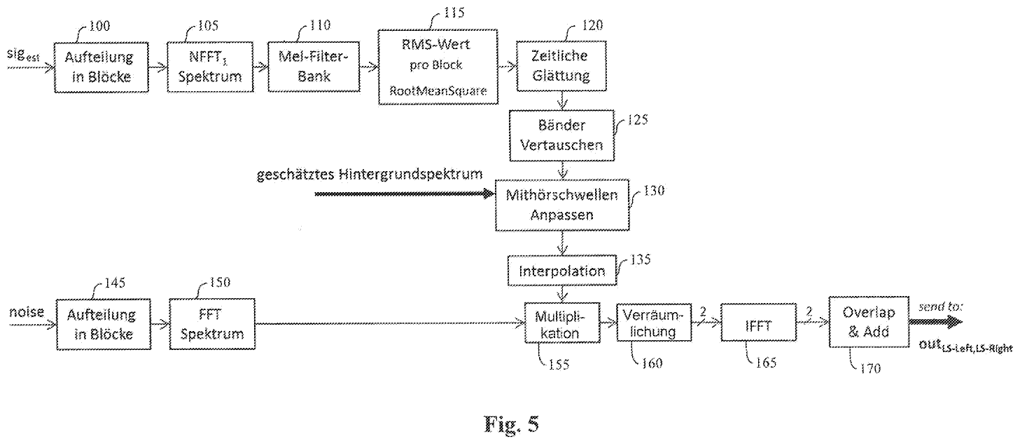

FIG. 5 shows an example of a block diagram for generating a broadband masking signal for speech obfuscation; and

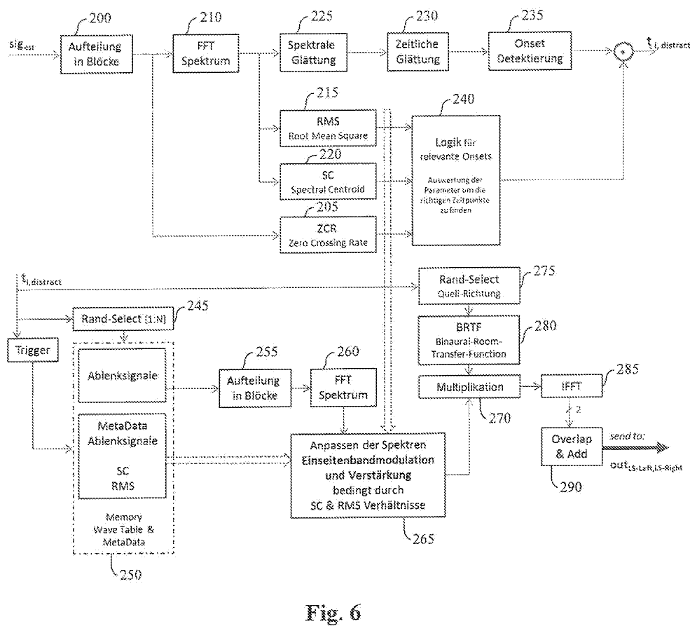

FIG. 6 shows an example of a block diagram for generating a distraction signal for speech obfuscation.

The embodiments described below are not limiting and are purely illustrative. For illustrative purposes, they include additional elements which are not essential to the invention. The scope of the invention is to be defined solely by the appended claims.

The following embodiments enable vehicle passengers in any seating position to have undisturbed private conversations, such as telephone calls with other persons outside the vehicle. For this purpose, an audio masking signal is generated and is provided to other vehicle passengers so that they are prevented from listening to the conversation so as undesirable listening to the private conversation is made more difficult and at best impossible. In this way, privacy is created for the speaker in which he can also hold private conversations undisturbed without the risk of other vehicle passengers being able to pick up confidential information. The conversation can, for example, be a telephone call or a conversation between vehicle passengers. In the latter case, there are two speakers who alternately emit speech signals that other passengers should not be able to understand, while, of course, speech intelligibility between the two conversation participants should not be compromised.

Similar scenarios generally occur when persons are located in acoustic zones or acoustic environments of a room, each of which is provided with sound by individual acoustic reproduction devices. For example, such acoustic zones can exist in transportation means, such as vehicles, trains, buses, airplanes, ferries, etc., in which passengers are located at seats that are each equipped with acoustic reproduction devices. However, the suggested approach for creating private acoustic zones is not limited to these examples. It can be applied more generally to situations in which persons are located at respective locations in a room (e.g. in theater or cinema seats) and can be exposed to sound by individual acoustic reproduction means and where it is possible to capture the speech signals of a speaker the speech of which is not intended to be understood by the other persons.

In one embodiment, a zone-based audio system is provided to create private acoustic zones at each passenger seat of a vehicle or, more generally, an acoustic environment. The individual components of the audio system are interconnected to each other and can interactively exchange information/signals. FIG. 1 schematically shows an example of such a zone-based audio system 1. A user or passenger is seated at a seat 2 with a headrest 3, the headrest having two loudspeakers 4 and two microphones 5.

Such a zone-based audio system has one, preferably at least two loudspeakers 4 for active acoustic reproduction of personal and individual audio signals, which should not or only slightly be perceived by the neighboring zones. The loudspeaker(s) 4 can be mounted in the headrest 3, the seat 2 itself or in the vehicle headliner. The loudspeakers have an appropriate acoustic design and can be controlled via appropriate signal processing to minimize the acoustic impact on adjacent zones.

Furthermore, such an audio zone has the capability of recording the speech of the passenger in the primary acoustic zone independently of the neighboring zones and the signals actively reproduced therein.

For this purpose, one or more microphones 5 can be integrated in the seat 2 or the headrest 3 or mounted in the direct acoustic environment of the zone and the passenger, as schematically shown in FIG. 2. Preferably, the microphones 5 are arranged in such a way that they enable the best possible detection of the speech of the passenger using the telephone. If a microphone can be placed in the immediate vicinity of the mouth of the person speaking (such as the center microphone in FIG. 2), a single microphone is generally sufficient to capture the audio signals of the person speaking with sufficient quality. For example, the microphone of a telephone headset can be used to capture the speech signals. Otherwise, two or more microphones are advantageous for capturing speech in order to record it more effectively and, above all, in a more targeted manner using digital signal processing, as explained below.

The audio zone of the speaker can have appropriate signal processing in order to record the voice signals of the primary passenger with as little disturbance as possible and unaffected by the neighboring zones and the prevailing disturbances in the environment (wind, rolling noise, ventilation, etc.).

The voice signal of the vehicle passenger on the phone is thus recorded at the seat position (either directly by a microphone arranged accordingly or indirectly by means of one or more remote microphones with appropriate signal processing) and separated from any interference signals, such as background noise.

From this speech signal, a masking signal, hereinafter also referred to as a speech obfuscation signal, can be generated for a passenger who is overhearing. In example embodiments, a broadband masking signal adapted to the speech to be obfuscated is generated for this passenger. Additionally or alternatively, distraction signals can also be generated at the individual speech onsets within the speech of the primary speaker. These are short interference signals that are emitted at certain speech segments that are important for speech intelligibility and can also be adapted to the speech to be obfuscated. These distraction signals are emitted to overlap with the speech segments relevant for speech intelligibility in order to reduce information contents for the listener and impair intelligibility of the speech or interpretation thereof (informational masking) without significantly increasing the overall sound level.

Adapted to the respective local acoustic requirements, these obfuscation signals can be delivered in a spatial manner (multi-channel) so that spatial perception of the obfuscation signals is created. In this way, overhearing at the seating positions of the listeners can be avoided as far as possible.

Using the approach proposed above, the overall sound pressure level at the seats of the passengers listening in is increased only minimally and the annoyance of the passengers is not increased or the local listening comfort is maintained in the best possible way, contrary to any approach in which a loud noise is simply output to cover the speech (energetic masking).

FIG. 3 shows an example of the functionality and basic system structure of an example embodiment for two audio zones. The passenger speech signals in the primary acoustic zone I are recorded by the microphones 5 of this zone, which are arranged in the headrest 3 of the speaker, and subjected to a first digital signal processing A to record the speech signals of the primary passenger as free of interference as possible and unaffected by the neighboring zones and the prevailing disturbances in the environment (wind, rolling noise, ventilation, etc.). Alternatively, the microphone or microphones 5 can also be arranged in front of the speaker, as shown in FIG. 2, for example in the rear part of the headrest of the front passenger or in the headliner, steering wheel or dashboard. In the example shown, the person overhearing is seated in the seat directly in front of the speaker, but this need not be the case and the person overhearing can be located at any other place within the vehicle.

The speech signals processed in this way are then fed to a second signal processing B, which generates suitable speech obfuscation signals such that speech intelligibility of the overhearing passenger is reduced. The speech obfuscation signals are then output via the loudspeakers 4′ in the second acoustic zone II. These are arranged, for example, in the headrest 3′ of the passenger who is overhearing so as to achieve the most direct and undisturbed reproduction of the speech obfuscation signals possible. As already mentioned, a speech obfuscation signal can have a broadband masking signal adapted to the speech signal of the primary passenger and/or a distraction signal that starts at individual speech onsets. In this way, acoustic zones can be made private such that undesired overhearing across the boundary of an acoustic zone is made significantly more difficult.

In an alternative approach-similar to active noise suppression—the estimated speech signals at the respective listening or microphone location are reduced by actively adding adaptive clearing signals.

However, as the listening position is slightly variable in practice and the listening and microphone locations are a few centimeters apart, only speech signal components up to around 1.5 kHz can be actively reduced. However, since speech intelligibility is primarily ruled by consonants, and thus signal components with frequencies above 2 kHz, this approach alone is inadequate or, at best, should also be contemplated as being critical, since in the event of inadequate tuning (e.g. incorrect adaptation to the head position), the clearing signals carry exactly the relevant private information and can even amplify it, so that speech intelligibility is increased instead of being reduced. In contrast, the disclosed approach is less sensitive to the exact head positions of the speaker and the person overhearing and allows for reduction in speech intelligibility even in case of higher frequency speech components such as consonants.

Due to the modularity of the disclosed approach, example embodiments involving multiple audio zones are also conceivable, for example in mass transportation (rail, airplane, train) or other fields of application (entertainment, cinema, etc.). FIG. 4 schematically illustrates such a multi-zone approach using a multi-row vehicle in which 6 acoustic zones are provided. As before, loudspeakers and microphones are integrated into the headrests of the passengers, where the microphones can also be arranged in other positions in front of the respective speakers in order to have a favorable arrangement for capturing the speech signals. Similar to FIG. 3, it is assumed in this example that the speaker is seated behind the undesirable overhearing passenger (in this case the driver). However, the voice signals of the speaking passenger can be used in the same way to generate masking or obfuscation signals for passengers other than the driver and also for several undesirable overhearers. Of course, the speaker can also be at a different location in the vehicle than in the example shown in FIG. 4. The approach disclosed herein can be applied in general to all scenarios in which the speech of a speaker can be detected and speech obfuscation signals generated can be output targeted to the unwanted overhearing person or persons.

As mentioned at the beginning, the voice signals can be a telephone conversation that the speaker has with an external person outside the room in which the acoustic zones are located. Alternatively, the conversation can be between persons in the room, for example between the speaker shown in FIG. 4 and the passenger to his right. In this case, the same signal processing as for the speaker shown must also be provided for the second speaker in the zone-based audio system, so that the speech of the second speaker is also detected and processed to generate suitable obfuscation signals for the overhearing person or persons. If the two speakers speak alternately, only the current speaker needs to be determined and the obfuscation signals associated with this speaker need to be output. If both speakers speak at the same time, both obfuscation signals can also be output simultaneously.

In the following, the signal processing steps required are described in an exemplary application. In this application, a vehicle passenger sitting in the rear left-hand seat is making a telephone call as an internal speaker to a person outside the vehicle. In addition to the speech of the internal speaker, the speech of the external speaker (far end speaker signal) emitted by the loudspeaker of the internal speaker's headrest, for example, can also be recorded as speech to be obfuscated. This is retouched or obfuscated for the overhearing driver in the “front left” position. Of course, this is only one possible scenario and the proposed procedures can generally be used for any possible configurations of speaker position and listening position arrangements.

The signal sigₑₛₜ estimated by means of digital signal processing A for the speech signal to be obfuscated provides the basic variable for the subsequent generation of the masking or obfuscation signal. The speech signal to be masked can be the active internal speaker in the vehicle and/or the external speaker outside. The obfuscation signal can be a broadband masking signal and/or a distraction signal. These generated signals (send to: out LS-Left & LS-Right) are reproduced via the active headrest at the listen—in position. In example embodiments, both obfuscation signals are generated, added and reproduced together to have an amplified effect on the overhearing and affect its intelligibility. Combination of the two obfuscation signals creates a synergetic effect of these signals in reducing speech intelligibility. The continuous broadband masking signal generates a background noise, thereby reducing the volume (energy) of the signal as compared to the output of only one noise signal, so that a less disturbing effect is achieved. By outputting the distraction signals punctually in time at suitable positions (speech onsets), the speech intelligibility of these speech segments (e.g. for consonants) is disturbed in a targeted manner without significantly increasing the overall energy of the obfuscation signal and causing additional unpleasant effects for the listener. It has even been found that the distraction signals are perceived as less unpleasant if they are presented together with the noise signal.

FIG. 5 shows a schematic block diagram for the generation of broadband speech signal-dependent masking. The input signal is the speech signal to be masked sigₑₛₜ. The resulting two-channel output signals (out LS-Left & LS-Right) are sent to the active neck rest at the overhearing position, superimposed with distraction signals if necessary, and output to the person overhearing by means of loudspeakers attached to/in the neck rest.

In the following, the signal processing steps for generating a broadband noise signal for speech masking according to an example embodiment are described in detail. It should be noted that it is not require to always perform all steps and some steps may be performed in a different order, as is known to persons skilled in the art of digital signal processing. Also, some calculations can be performed equivalently in the frequency domain or in the time domain.

First, the speech signal sigₑₛₜ is transformed into the frequency domain and smoothed both in terms of time and frequency direction. For this purpose, the speech signal sigₑₛₜ is first divided into blocks in section 100 (for example, 512 samples at a sampling rate of fs=44.1 kHz are arranged in blocks with a duration of 11.6 ms and 50% overlap). Each signal block in section 105 is then transformed into the frequency domain using a Fourier transformation with NFFT1=1024 points.

In a further step 110, the Fourier spectra are filtered with a Mel filter bank with M=24 bands i.e. the spectra are spectrally compressed by the Mel filter bank. The filter bank can consist of overlapping bands with a triangular frequency response. The center frequencies of the bands are divided equidistantly across the Mel scale. The lowest frequency band of the filter bank starts at 0 Hz and the highest frequency band ends at half the sampling rate (fs). A short-time energy value (RMS level or specific loudness curves of the individual Mel bands) is calculated for each signal block in section 115 of the block diagram for all bands of the filter bank. These short-time energy values are averaged over time in section 120 over MA=120 blocks in the form of a sliding average (moving average, 120 blocks corresponding to approx. 700 ms).

In example embodiments, in section 125 these dynamic loudness curves are commuted in the immediate frequency environment (scrambling). For this purpose, the loudness values of the bands are commuted according to the following table, with the assignment of the band “in” being derived from the corresponding position in the line “out” below. For example, the loudness value of band number 2 is assigned to band number 4. Band number 4 and the value of band 4 is assigned to band 5, whose value is assigned to band 3, etc. This results in the loudness values being commuted with neighboring bands or the band after next, i.e. the difference between a mel band and a commuted band is a maximum of two mel bands in this example. Of course, the table shown is only one possible example of how bands can be commuted and other realizations are also possible.

| | Band assignment | | | | | | | | | | | | | | | | | | | | | | | |
|---|---|---|---|---|---|---|---|---|---|---|---|---|---|---|---|---|---|---|---|---|---|---|---|---|
| in | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 |
| out | 1 | 4 | 2 | 5 | 3 | 6 | 7 | 10 | 8 | 11 | 9 | 12 | 13 | 16 | 14 | 17 | 15 | 18 | 19 | 22 | 20 | 23 | 21 | 24 |

By means of the proposed band commutation, the loudness values are “scrambled” so that a certain “disorder” is created in the distribution of the loudness values for an associated speech segment, thereby changing the description of the spectral energy or loudness distribution thereof without changing the overall energy or loudness of the speech segment. For example, a particularly pronounced energy content in one band is shifted to another band or a low energy (loudness) in one band is transformed to a neighboring band. It has been shown that by redistributing the energy into neighboring bands, a particularly effective broadband noise signal can be generated, which reduces the intelligibility of the associated speech segment more than without band commuting. By commuting/reversing the sequence of the bins of the temporally dynamic progressions of the masking bands, transmission of speech information in the noise signal is avoided. If the speech energy were captured in frequency bands (e.g. Mel bands as described above) and the amplitude of these temporal energy curves were modulated directly onto a noise signal, also divided into equal frequency bands, then the speech content would be audible- and all the more intelligible if narrow frequency bands are used. This effect is significantly reduced by band commutation of the loudness values.

The dynamic loudness curves, which if necessary are commuted, can be adjusted using the current background spectra (including all background noise) in section 130 of the block diagram to evaluate background noise and ambient situation. For this purpose, the background noise is detected, for example, at the monitoring position and, similar to the speech signal, the background spectra are determined using frequency transformation and time and frequency averaging. Preferably, a microphone located at the listening position is used for this purpose. Alternatively, microphones located elsewhere (but preferably close to the monitoring position) can be used to capture the background noise at the monitoring position. Only those bands of the speech signal that are above the background spectrum need to be contemplated when generating the masking signal. Speech bands the energy of which is below the energy of the corresponding background noise band can be neglected, as they do not play a role in speech intelligibility or are already masked by the background noise. This can be done, for example, by setting the loudness value of such speech bands to zero. In other words, if a frequency band is already masked by a strong background noise, no additional masking signal is generated in this frequency band. The decision as to which signal components of the broadband masking noise are used to obfuscate speech is thus made on a situational basis.

In section 135, interpolation of the resulting co-listening thresholds (frequency axis sampled at 24 frequencies corresponding to the 24 center frequencies of the Mel filter bank) occurs at all frequency sampling points of the Fourier transform. The interpolation generates a spectral value for the speech signal for the entire frequency range of the Fourier transformation, for example 1024 values for the above-mentioned Fourier transformation with NFFT1=1024 points.

Finally, in section 155, point-by-point multiplication of the frequency grid points (or a convolution in the time domain) of the frequency values generated in this way is performed using a noise spectrum. This can be obtained by a noise generator (not shown), the noise signal of which runs through a block segmentation 145 and Fourier transformation 150 with the same dimensions in the same way as the speech signal. In this way, a broadband noise signal is generated as a masking signal with a similar frequency characteristic (apart from commuting and zeroing of sections 125 and 130) as the speech signal. Alternatively, the masking signal can also be generated in the time domain by convolution of the noise signal with the spectral values of the speech signal processed as described above (see sections 100 to 135) transformed back into the time domain. By switching between the frequency and time domains, different frequency resolutions or time durations can be used in the various processing steps. Alternatively, it is also possible to carry out the entire processing in the frequency domain. In this way, a broadband noise spectrum adapted to the speech segment of the block is generated for each block of the speech signal.

In example embodiments, section 160 is followed by spatial processing using point-by-point multiplication of the frequency grid points (or convolution in the time domain, see above) with binaural spectra of an acoustic transfer function that corresponds to the source direction of the speaker (or the dominant direction of the energy centroid of the speech signal to be masked) from the perspective of the person overhearing. The source direction of the speaker is known from the spatial arrangement of the acoustic zones. In the example shown in FIG. 4, the source direction of the speaker is directly behind the person overhearing. In example embodiments with spatial orientation of the masking signal, multi-channel playback (e.g. using two loudspeakers) is required. Otherwise, single-channel playback is sufficient, which preferably also occurs by means of two loudspeakers arranged in the neck rest of the person overhearing.

The broadband masking signal can thus be spatially reproduced and adapted to the target direction of the direct signal or the prominently perceived direction of the speaker. Due to the binaural loudness addition, significantly improved masking is done with lower level excesses of the masking noise.

In section 165, a back-transformation (IFFT) of the two resulting spectra (for spatial playback) (per block) into the time domain and an overlap of the blocks using the overlap-add method is performed (see section 170). It is noted that for spatial reproduction, a multi-channel signal is produced, which can be played back, for example, by stereo playback. If the previous steps have already been carried out in the time domain, it is understood that back-transformation and overlapping of the blocks will be omitted.

The resulting time signals are sent to the respective active neck rest of the overhearing person. There, in example embodiments in which distraction signals are also generated, the masking signals can be summed with the distraction signals before being output via the speakers of the neck rest.

As already mentioned, signal processing can be carried out partly in the frequency domain or in the time domain, although it is as well possible to carry out the entire processing in the frequency domain. The specific values mentioned above are only examples of a possible configuration and can be changed in many ways. For example, a frequency resolution of the FFT transformation with less than 1024 points or a division of the Mel filters with more or less than 24 filters is possible. It is also possible that frequency transformation of the noise signal is performed with different configuration of the block size and/or the FFT than that of the speech signal. In this case, the interpolation in section 135 would have to be adjusted accordingly to generate suitable frequency values. In yet another variation, the blockwise calculated masking noises are first retransformed into the time domain after interpolation and then brought back into the frequency domain to allow for spatialization-possibly with a different spectral resolution. Persons skilled in the art will recognize such variations of the procedure according to the invention for generating a broadband speech signal-dependent masking signal after studying the present disclosure.

In example embodiments, instead of masking noise, short duration distraction signals are used, which are adapted in terms of time and/or frequency to sections of the speech signal that are particularly relevant for intelligibility. As an example, the generation of such distraction signals is described below. FIG. 6 schematically shows an example of a block diagram for generating speech signal-dependent distraction signals. Distraction of the overhearing person is done at signal-dependent defined time points. For this purpose, the critical time points (t_{i,distract}) are determined using three information parameters in the speech signal: spectral centroid “SC” (roughly corresponds to the pitch), short-time energy “RMS” (roughly corresponds to the volume) and number of zero crossings “ZCR” (to distinguish between speech signal/background noise).

A series of pre-selected distraction signals (e.g. bird calls, chirps, . . . ) with associated parameters (SC and RMS), collected by additional preliminary analyses, are stored in a digital memory. Suitable distraction signals preferably have the following properties: On the one hand, they are natural signals that are familiar to the listener from other situations/daily life and are therefore not associated with the signal and context to be masked. Furthermore, they are characterized by the fact that they are acoustically distinctive signals of short duration and have the broadest possible spectrum. Other examples of such signals are water dripping noises or water wave impacts or brief gusts of wind. Usually, the distraction signals are longer than the relevant speech segments (e.g. consonants) covering them completely. It is also possible to store distraction signals of different lengths and select them to match the duration of the current critical moment.

A distraction signal is selected and adapted to the current speech segment in terms of time and frequency. The adapted distraction signal can then be reproduced to the overhearing person from a virtual spatial position. For spatialization (BRTF), short impulse responses (256 points) can be used to simulate the outer ear transfer function so that these distraction signals are localized by the overhearing person as close and present to the head as possible, thus achieving a strong distraction effect. Multi-channel (e.g. stereo) playback is required for spatial reproduction.

In the following, the signal processing steps for generating discrete, spatially distributed, short distraction signals according to an example embodiment are described in detail. It should be noted that not all steps are always required and some steps may be performed in a different order, as persons skilled in the art will recognize. Also, some calculations can equivalently be performed in the frequency domain or in the time domain. Some of the processing steps correspond to those for generating broadband masking signals and therefore do not need to be performed a second time in example embodiments that use both types of signals for speech obfuscation.

In section 200, the speech signal sigₑₛₜ is divided into blocks (BlockLength=512 samples, fs=44.1 kHz) with a duration of 11.6 ms and 50% overlap (HopSize=256) (see section 100).

From these blocks XBufferₙ(m), wherein n=block index and m=time sample, the number of zero crossings (zero-crossing-rate, ZCR) per signal block is determined in section 205. This can be performed using the following formula:

$$ZCR ( n ) = 0.5 * {\sum }_{m = 1}^{mBlockLength - 1} \vert sgn ( {XBuffer}_{n} ( m + 1 ) ) - sgn ( {XBuffer}_{n} ( m ) ) \vert$$

In section 210, each signal block is subjected to a Fourier transformation with NFFT2=1024 points (see section 105).

From these spectra S(k,n) wherein k=frequency index and n=block index, two further parameters are calculated in sections 215 and 220: the short-time energy (RMS) and the spectral centroid (SC):

$$RMS ( n ) = \sqrt{{\sum }_{k} {‖ S ( k , n ) ‖}^{2}}$$

$$SC ( n ) = \frac{{\sum }_{k = 1}^{\frac{{NFFT}_{2}}{2} + 1} k * \vert S ( k , n ) \vert}{{\sum }_{k = 1}^{\frac{{NFFT}_{2}}{2} + 1} \vert S ( k , n ) \vert}$$

The courses of the short-time energy RMS and the zero crossing rate ZCR can also be filtered using signal-dependent threshold values and areas that do not meet these threshold values can be ignored (e.g. set to zero). The threshold values can, for example, be selected so that a certain percentage of the signal values are above or below them.

Each spectrum is spectrally smoothed in section 225 with a recursive discrete-time filter of 1st order:

H(z)=Bs(z)/As(z),

wherein

Bs=0.3

and

As(z)=1−(Bs−1)*z−1

in both directions (=acau-sales, zero-phase filter of 2nd order).

The resulting spectra are smoothed in time in section 230 using a recursive 1st order discrete-time filter:

H(z)=Bt(z)/At(z),

wherein

Bt=0.3

and

At(z)=1−(Bt−1)*z−1.

For detection of speech signal sections (onsets) that are relevant for speech intelligibility (onset detection), an onset detection function is first determined in section 235. For this purpose, the spectrally and temporally averaged spectra are added across the frequency axis. The resulting signal is logarithmized and time-differentiated, with negative values being set to zero. Regularization (e.g. addition of a small number at all frequency grid points) can be performed before logarithmization to avoid zero values.

This onset detection function is scanned for local maxima, the local maxima being required to be spaced apart at least by a specified number of blocks. The maxima found in this way can be filtered further using a signal-dependent threshold value so that only particularly pronounced maxima remain. Local maxima of the onset detection function determined in this way are candidates for perceptually relevant segments of the speech signal that are to be selectively disturbed using a distraction signal.

In example embodiments, the maxima of the onset detection function thus determined in section 240 are checked for plausibility via a logic unit using the parameters: ZCR, RMS and SC. Only if these values are within a defined range are these maxima set as relevant, critical time points t_{i,distract}. This can for example occur in that at the times of determined maxima of the onset detection function, the values of RMS, SC and/or ZCR must satisfy certain logical conditions (e.g. RMS>X1; X2<SC<X3; ZCR>X4 with predetermined threshold values X1 to X4). In example embodiments, for example, only maxima that are located in time periods that satisfy the above filter conditions for RMS and ZCR (i.e. are not in hidden ranges) are contemplated. The condition that ZCR and RMS must simultaneously satisfy certain threshold conditions can also be used to filter the course of SC by retaining the values of SC when the threshold conditions are satisfied and interpolating or extrapolating interposed values, resulting in the function SCᵢₙₜ.

At the determined time points t_{i,distract}, one distraction signal is randomly selected among a selection of N distraction signals stored digitally in a memory 250 (using section 245). The memory 250 contains additional metadata for these distraction signals: SC and RMS values.

The selected distraction signal is divided into blocks in section 255 (see above with BlockLength₂ and Hopsize=BlockLength₂ or Overlap=0, respectively) and then Fourier transformed in section 260 with NFFT2 points. The parameters of this frequency transformation can be different from and independent of the above version for the speech signal to be masked. Alternatively, the frequency representation of a distraction signal could be stored directly in the frequency domain.

The resulting spectra can be adapted in section 265 depending on the signal from sigₑₛₜ at the respective time t_{i,distract} using the SC parameter ratios in the frequency position (e.g. by single-sideband modulation) and/or using the RMS parameter ratios in the gain. For this purpose, the ratio of the spectral centroids SC of the respective speech signal section at an onset time t, distract and the associated distraction signal is formed and the frequency position of the distraction signal is adjusted such that it matches that of the speech signal as closely as possible. This can be performed by comparing the value of the function SCᵢₙₜ of the interpolated spectral centroid at an onset time SCᵢₙₜ {t_{i,distract}) with the SC value of the selected distraction signal and determining a detuning parameter, with positive values of the detuning parameter meaning an increase in the pitch of the distraction signal by means of single-sideband modulation and negative values leading to a lowering of the pitch.

The energy (RMS) of the distraction signal is also adapted to the energy of the speech signal section, so that a predetermined energy ratio for the distraction signal to speech signal is achieved. Due to high effectiveness in reducing speech intelligibility, the distraction signals can be reproduced at a low volume so that the overall sound pressure level at the seat positions of the overhearing passengers increases only minimally and the annoyance or impairment of the passengers is not increased or the local listening comfort is maintained in the best possible way.

In example embodiments, the resulting modified spectra of the distraction signals are mapped spatially variable by a binaural spatial transfer function (BRTF) depending on a random direction selection per t_{i,distract} time point in section 270 using point-wise multiplication of the frequency grid points (or convolution in the time domain) of the corresponding spectra. In addition, a direction is randomly selected for a deflection signal in section 275. The memory 280 contains binaural spatial transfer functions (BRTF) matching the possible directions. As already explained above for the masking noise, spatialization can be performed in the frequency or time domain. In the time domain, a convolution is performed with the impulse response of a selected outer ear transfer function. The spatialization of the distraction signals is preferably performed such that the distraction signals are localized as close and present as possible to the head by the overhearing person to achieve a strong distraction effect. Multi-channel (e.g. stereo) playback is required for spatial reproduction, otherwise single-channel playback would be sufficient, although this could preferably also be achieved using two loudspeakers integrated in the headrest.

In case of spatialization of the distraction signal in the frequency domain, the convolution results are transformed back into the time domain in section 285 by an inverse Fourier transform (IFFT) with NFFT2 points. The back-transformed time blocks are combined into a time signal in section 290 using the overlap-add method. If the previous steps have already been carried out in the time domain, reverse transformation and overlapping of the blocks can obviously be omitted.

The resulting time signals are sent to the respective active neck rest of the overhearing person. In example embodiments in which masking noise signals are also generated, the masking signals can there be summed with the distraction signals before being output via the speakers of the neck rest.

The speech signal-matched distraction signal generates randomly distributed excitation/trigger information improving the speech target signal without significant permanently impacting signal levels.

As already mentioned, signal processing can be carried out partly in the frequency domain or in the time domain. The specific values mentioned above are only examples of any possible configuration of the frequency transformation and can be changed in many ways. In one possible variation, the energy and frequency matched spectra (see section 265) are first back-transformed into the time domain and then returned to the frequency domain again to account for spatialization-possibly with a different spectral resolution. However, it is also possible to carry out the entire processing in the frequency domain. Persons skilled in the art of digital signal processing will recognize such variations of the procedure according to the invention for generating speech signal-dependent distraction signals after having studied the present disclosure.

In example embodiments, both obfuscation signals-broadband masking noise and distraction signals—are summed before being output and co-reproduced. The masking noise, which is preferably perceived from the direction of the speaker, generates a broadband noise signal adapted to the spectral properties of the respective speech segment, to which short distraction signals are selectively superimposed (in terms of time and frequency) at particularly relevant points. These distraction signals are perceived spatially close to the head resulting in particularly effective reduction in speech intelligibility, even if they are reproduced at low volume or energy. However, due to the combination with the broadband masking noise, the brief on and off switching of the distraction signals is perceived as less disturbing or impairing. The overall sound pressure level at the seat positions of the overhearing passengers increases only minimally and the annoyance or impairment of the passengers is not increased or the local listening comfort is maintained as best as possible.

The above description of example embodiments has a variety of details that are not essential to the invention as defined by the claims. The description of the example embodiments is intended for understanding of the invention and is purely illustrative and without limiting effect on the scope of protection. It will be apparent to persons skilled in the art that the described elements and their technical effects can be combined with each other in different ways, so that further example embodiments covered by the claims may arise. Furthermore, the technical features described can be used in devices and methods, for example implemented by programmable devices. In particular, they can be implemented by hardware elements or by software. As is known, the implementation of digital signal processing is preferably performed by specifically designed signal processors. Communication between individual components of the device described can occur by wire (e.g. by means of a bus system) or wirelessly (e.g. by means of Bluetooth or WiFi). Protection is also expressly claimed for a computer-implemented realization and the associated program or machine code in the form of data carriers or in a downloadable representation.

1. A method of masking a speech signal in a zone-based audio system, comprising:
detecting a speech signal to be masked in an audio zone;
transforming the detected speech signal into spectral bands;
commuting spectral values of at least two spectral bands;
generating a noise signal based on the commuted spectral values; and
outputting the noise signal as a masking signal for the speech signal in another audio zone.

2. The method according to claim 1, wherein generating a noise signal based on the commuted spectral values comprises:
generating a broadband noise signal;
transforming the generated noise signal into the frequency domain; and
multiplying the frequency representation of the noise signal by a frequency representation of the speech signal while considering the commuted spectral values.

3. The method according to claim 2, wherein the frequency representation of the speech signal is generated by interpolating the spectral values of the bands following commutation of spectral values.

4. The method according to one of the preceding claims, further comprising:
estimating a background noise spectrum;
comparing spectral values of the speech signal with the background noise spectrum; and
solely considering spectral values of the speech signal that are greater than the corresponding spectral values of the background noise spectrum.

5. The method according to one of the previous claims, wherein transformation of the detected speech signal is into spectral bands for blocks of the speech signal and by means of a Mel filter bank and optionally temporal smoothing of the spectral values for the Mel bands is performed.

6. The method according to one of the preceding claims, wherein the noise signal is spatially represented in the output by means of a multi-channel playback, preferably by multiplication by binaural spectra of an acoustic transfer function.

7. The method according to claim 6, wherein the noise signal is spatially output in the other audio zone such that it appears to originate from the predominant direction of the speaker of the speech signal to be masked.

8. The method according to one of the preceding claims, further comprising:
determining a time point in the speech signal relevant for speech intelligibility;
generating a distraction signal for the time point as determined; and
outputting the distraction signal at the determined time point as another masking signal in the other audio zone.

9. The method according to claim 8, wherein the time point relevant for speech intelligibility is determined using extreme values of a spectral function of the speech signal, wherein the spectral function is determined based on an addition of, optionally averaged, spectral values over the frequency axis.

10. The method according to claim 8 or 9, wherein the time point relevant for speech intelligibility is verified using parameters of the speech signal, such as zero crossing rate, short time energy and/or spectral centroid.

11. The method according to one of the claims 8 to 10, wherein the distraction signal for the particular time point is randomly selected among a set of predetermined distraction signals and/or is adapted to the speech signal in terms of a spectral characteristic and/or energy thereof.

12. A method of masking a speech signal in a zone-based audio system, comprising:
Detecting a speech signal to be masked in an audio zone;
determining a time point in the speech signal relevant to speech intelligibility;
generating a distraction signal for the time point as determined, the distraction signal being adapted to the speech signal in terms of a spectral characteristic and/or energy thereof; and
outputting the distraction signal as a masking signal at the specific time point in another audio zone.

13. The method according to claim 12, wherein the time point relevant for speech intelligibility is determined using extreme values of a spectral function of the speech signal, wherein the spectral function is determined based on an addition of, optionally averaged, spectral values over the frequency axis.

14. The method according to claim 12 or 13, wherein the time point relevant for speech intelligibility is verified using parameters of the speech signal, such as zero crossing rate, short time energy and/or spectral centroid.

15. The method according to one of the claims 12 to 14, wherein the distraction signal for the particular time point is randomly selected among a set of predetermined distraction signals.

16. The method according to one of the claims 12 to 15, further comprising:
transforming the captured speech signal into spectral bands;
commuting spectral values of at least two spectral bands;
generating a noise signal based on the commuted spectral values; and
outputting the noise signal as an additional masking signal for the speech signal in the other audio zone.

17. The method according to claim 16, wherein generating a noise signal based on the commuted spectral values comprises:
generating a broadband noise signal;
transforming the generated noise signal into the frequency domain; and
multiplying the frequency representation of the noise signal by a frequency representation of the speech signal while considering the commuted spectral values.

18. The method according to one of the claim 16 or 17, further comprising:
estimating a background noise spectrum;
comparing spectral values of the speech signal with the background noise spectrum; and
considering only spectral values of the speech signal that are greater than the corresponding spectral values of the background noise spectrum.

19. The method according to one of the claims 16 to 18, wherein transformation of the captured speech signal into spectral bands is for blocks of the speech signal and is performed using a Mel filter bank, and optionally temporal smoothing of the spectral values for the Mel bands is performed.

20. The method according to one of the claims 1 to 19, wherein the masking signal is spatially represented in the output using multi-channel playback in the other audio zone, preferably by multiplication by binaural spectra of an acoustic transfer function.

21. The method according to claim 20, wherein the masking signal is spatially output in the other audio zone such that it appears to originate from a random direction and/or near the head of a listener in the other audio zone.

22. A device for generating a masking signal in a zone-based audio system which receives a speech signal to be masked and generates the masking signal based on the speech signal, comprising:
means for transforming the detected speech signal into spectral bands;
means for commuting spectral values of at least two spectral bands; and
means for generating a noise signal as a masking signal based on the commuted spectral values.

23. The device according to claim 22, further comprising:
means for determining a time point in the speech signal relevant to speech intelligibility;
means for generating a distraction signal for the relevant time point; and
means for adding the noise signal and the distraction signal and outputting the sum signal as a masking signal.

24. A device for generating a masking signal in a zone-based audio system which receives a speech signal to be masked in an audio zone and generates the masking signal based on the speech signal, comprising:
means for determining a time point in the speech signal relevant to speech intelligibility;
means for generating a distraction signal for the relevant time point, wherein the distraction signal is adapted to the speech signal with respect to a spectral characteristic and/or energy thereof; and
means for outputting the distraction signal as a masking signal at the specific time point in another audio zone.

25. The device according to claim 24, further comprising:
means for transforming the detected speech signal into spectral bands;
means for commuting spectral values of at least two spectral bands; and
means for generating a noise signal as a masking signal based on the commuted spectral values; and
means for adding the noise signal and the distraction signal and outputting the sum signal as a masking signal.

26. The device according to one of the claims 22 to 25, further comprising:
means for generating a multi-channel representation of the masking signal, enabling spatial reproduction of the masking signal.

27. A zone-based audio system comprising a plurality of audio zones, one audio zone comprising at least one microphone for detecting a speech signal and another audio zone comprising at least one loudspeaker, the microphone and loudspeaker preferably being arranged in headrests of seats for passengers of a vehicle, the audio system comprising a device for generating a masking signal according to claims 22 to 26, which receives a speech signal from a microphone of the one audio zone and sends the masking signal to the loudspeaker or loudspeakers of the other audio zone.
